(19) United States
(12) Patent Application Publication
(10) Pub. No.: US 2012/0223895 A1
(43) Pub. Date: Sep. 6, 2012

(54) Single-Finger and Multi-Touch Gesture Determination Method, Touch Control Chip, Touch Control System and Computer System

(76) Inventors: Yu-Tsung Lu, Hsinchu City (TW); Ching-Chun Lin, New Taipei City (TW); Jiun-Jie Tsai, Hsinchu City (TW); Tsen-Wei Chang, Taichung City (TW); Ting-Wei Lin, Hualien County (TW); Hao-Jan Huang, Hsinchu City (TW); Ching-Ho Hung, Hsinchu City (TW)

(21) Appl. No.: 13/195,018

(22) Filed: Aug. 1, 2011

(30) Foreign Application Priority Data
Mar. 4, 2011 (TW) 100107299

(51) Int. Cl. G06F 3/041

(52) U.S. Cl. 345/173

(57) ABSTRACT

A single-finger and multi-touch gesture determination method is disclosed. The single touch and multi-touch gesture determination method includes steps of: for each of one or more touch points, judging a respective category under a first group to which the touch point belongs, according to an initial position of the touch point; for each of the one or more touch points, judging a respective category under a second group to which the touch point belongs, according to a moving pattern of the touch point, wherein the moving pattern is respectively defined in the judged category under the first group to which the touch point belongs; and determining a gesture represented by the one or more touch points according to the judged categories under the second group respectively to which the one or more touch points belong.

### BACKGROUND OF THE INVENTION

1. Field of the Invention

The present invention relates to a single-finger and multi-touch (multi-finger) gesture determination method, and more particularly, to a single-finger and multi-touch gesture determination method capable of deciding a gesture corresponding to each touch point without having to perform complex cross-calculations between touch points, and a touch control chip and a touch control system and computer system using the same

2. Description of the Prior Art

Generally, touch sensing devices such as capacitive, resistive and other types of touch sensing devices, are capable of generating detecting signals related to an user's touch event to a touch sensing chip; the chip then compares the signal values of the detecting signals with threshold values to determine a touch point, and in turn, a gesture, according to the results. In the example of capacitive touch sensing devices, touch events are determined by detecting the capacitance difference generated when the human body touches a touch point on the touch panel; in other words, capacitive touch sensing is implemented through determining a touch point, and in turn, a touch event, by detecting the variations in capacitance characteristics when the human body touches the touch point.

Specifically, please refer to FIG. 1, which illustrates a conventional projected capacitive touch sensing device 10. The projected capacitive touch sensing device 10 includes sensing capacitor strings X₁-Xₘ, Y₁-Yₙ; each sensing capacitor string is a one-dimensional structure formed by connecting a plurality of sensing capacitor in series. Conventional touch sensing methods resort to detecting the capacitance in each sensing capacitor string to determine whether a touch event occurs. The sensing capacitor strings X₁-Xₘ and Y₁-Yₙ are utilized to determine vertical and horizontal touch events, respectively. In the case of horizontal operations, assume the sensing capacitor string X₁ has Q sensing capacitors, each sensing capacitor with a capacitance of C, then under normal circumstances, the sensing capacitor string X₁ has a capacitance of QC; and when the human body (e.g. a finger) comes in contact with a sensing capacitor of the sensing capacitor string X₁, assume the difference in capacitance is ΔC. It follows that, if the capacitance of the sensing capacitor string X₁ is detected to be greater than or equal to a predefined value (e.g. QC+ΔC), it can be inferred that the finger is touching a certain point on the sensing capacitor string X₁. Likewise, the similar may be asserted for vertical operations. As illustrated in FIG. 1, when the finger touches a touch point TP₁ (i.e. coordinates (X₃, Y₃)), the capacitance in the sensing capacitor strings X₃ and Y₃ concurrently varies, and it may be determined that the touch point falls at the coordinates (X₃, Y₃). Notice, however, that the threshold capacitance of the sensing capacitor strings X₁-Xₘ, for determining vertical directions, and the threshold capacitance of the sensing capacitor strings Y₁-Yₙ, for determining horizontal directions, do not necessarily have to be the same, depending on the practical requirement.

As can be seen from the above, the touch control chip compares signal values of the detecting signals generated by the touch sensing device with predefined threshold values; thus, it is possible to determine positions of all touch points and continuous occurrence times from start to end of a touch event, and in turn, to determine a gesture. In such a case, when determining a multi-touch gesture in the prior art, it is often required to perform complex cross-calculations on one or more touch points corresponding to multiple touch objects, to decide a corresponding gesture according to moving pattern parameters of the one or more touch points, e.g. relative positions. For example, when determining a two-point touch gesture in the prior art, it can be determined as a zoom-in gesture when a distance between the two touch points increases; it can be determined to be a zoom-out gesture when the distance between the two touch points decreases. On the other hand, when the distance between the two touch points remains constant and only a first of the two touch points moves (i.e. the first touch point moves along a circumference of a circle having the second touch point as the center), it can be determined to be a clockwise or counterclockwise rotation gesture, according to a moving direction of the first touch point.

However, as can be seen from the above, when determining multi-touch gestures in the prior art, it is necessary to perform complex cross-calculations on the one or more touch points corresponding to the multiple touch objects, to decide a corresponding gesture; therefore, the calculations for the relative positions would render the determination process over-complicated.

Moreover, since it is not possible to precisely meet the required moving pattern parameters, e.g. relative position, when performing a specific multi-touch gesture, it is necessary to set a larger error margin to prevent a faulty determination. For example, when performing a rotation gesture, it is impossible to maintain an absolute constant distance between two touch points; therefore, to prevent the rotation gesture from being determined as a zoom-in/out gesture by mistake, it is necessary to set a tolerable error margin, such that the touch points maybe determined to be a rotation gesture providing that a variation in the distance between the two touch points is within the tolerable error margin.

Hence, to prevent complex cross-calculations between the touch points and to allow a more accurate determination for multi-touch gestures, it is necessary to improve over multi-touch gesture determination methods of the prior art.

### SUMMARY OF THE INVENTION

Therefore, one of the primary objectives of the disclosure is to provide a single-finger and multi-touch gesture determination method, a touch control chip and a touch control system and computer system utilizing the same, which are capable of simply determining various single finger gestures by using common categorizing criteria.

In an aspect, a single-finger and multi-touch gesture determination method is disclosed. The single-finger and multi-touch gesture determination method includes: for each of one or more touch points, judging a respective category under a first group to which the touch point belongs, according to an initial position of the touch point; for each of the one or more touch points, judging a respective category under a second group to which the touch point belongs, according to a moving pattern of the touch point, wherein the moving pattern is respectively defined in the judged category under the first group to which the touch point belongs; and determining a gesture represented by the one or more touch points according to the judged categories under the second group respectively to which the one or more touch points belong.

In anther aspect, a touch control chip is disclosed. The touch control chip includes a determining unit, for determining a respective category under a first group to which each of a plurality of touch points belongs, according to an initial position of the touch point, and for determining a respective category under a second group to which each of the plurality of the touch points belongs, according to a moving pattern respectively defined in the determined category under the first group to which the touch point belongs; and a decision unit, for determining a gesture represented by the one or more touch points according to the respective determined categories under the second group to which the one or more touch points belong.

Furthermore, in yet another aspect, a touch control system is further disclosed. The touch control system includes a touch sensing device, for generating one or more signal values of one or more detecting signals; and the above-mentioned touch control chip, for determining one or more touch points and a gesture represented by the one or more touch points, according to the one or more signal values of the one or more detecting signals generated by the touch sensing device.

Furthermore, another embodiment further discloses a computer system, including the above-mentioned touch control system, for determining a gesture represented by one or more touch points; and a host, for receiving a packet of the gesture from the touch control system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional projected capacitive touch sensing device.

FIG. 2A a functional block diagram of a computer system according to an embodiment.

FIG. 2B is a schematic diagram of the touch control chip shown in FIG. 2A determining a gesture according to an embodiment.

FIG. 3 is a schematic diagram of the touch control chip in FIG. 2A taking four corners of a touch sensing device as targets of a position category, according to an embodiment.

FIGS. 4A to 7B are schematic diagrams of the touch control chip in FIG. 3 deciding, according to a direction parameter of a moving pattern, a gesture corresponding to a touch point in different position groups, according to an embodiment.

FIG. 8 is a schematic diagram of the touch control chip in FIG. 3 deciding a specific gesture corresponding to 2 touch points, according to an embodiment.

FIG. 9 is a schematic diagram of the touch control chip in FIG. 3 deciding a specific gesture corresponding to 2 touch points, according to an embodiment.

FIGS. 10A and 10B are schematic diagrams of the touch control chip in FIG. 3 deciding a specific gesture corresponding to 2 touch points, according to an embodiment.

FIGS. 11A to 11C are schematic diagrams of the touch control chip in FIG. 3 deciding a specific gesture corresponding to a touch point, according to an embodiment.

FIG. 12 is a schematic diagram of a single-finger and multi-touch gesture determination process, according to an embodiment.

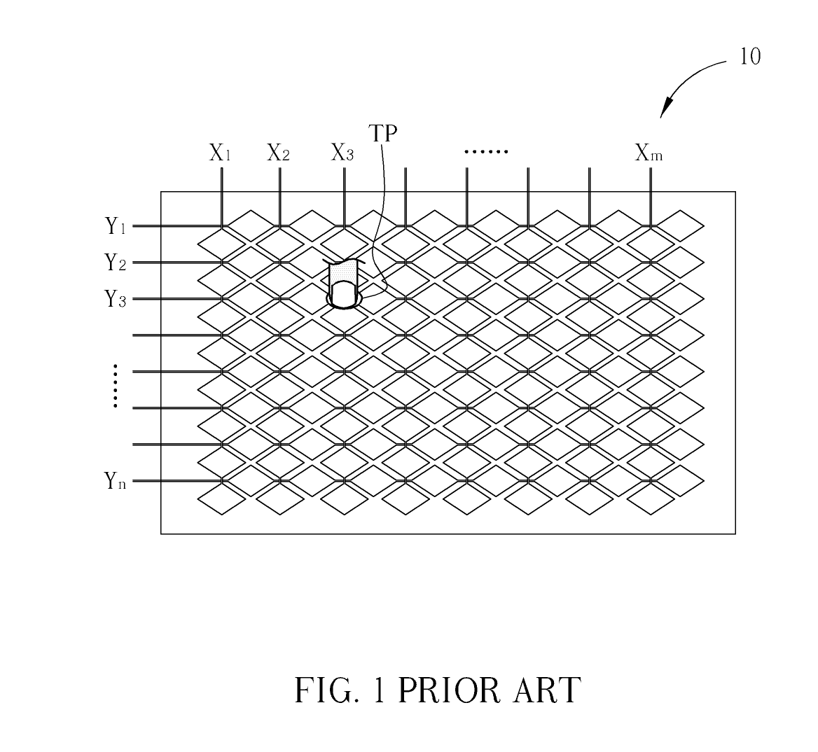

### DETAILED DESCRIPTION

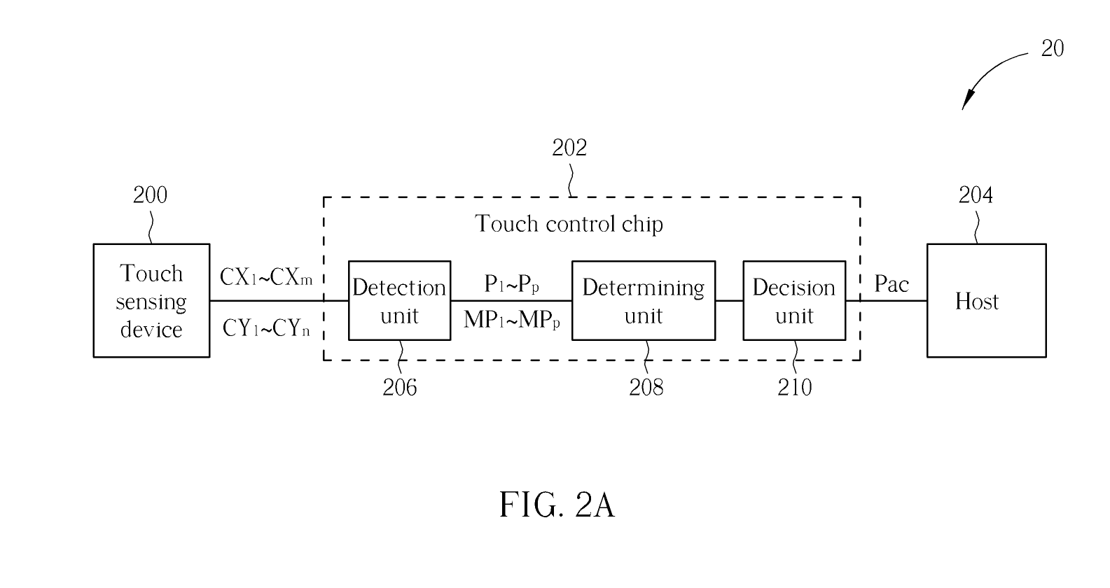

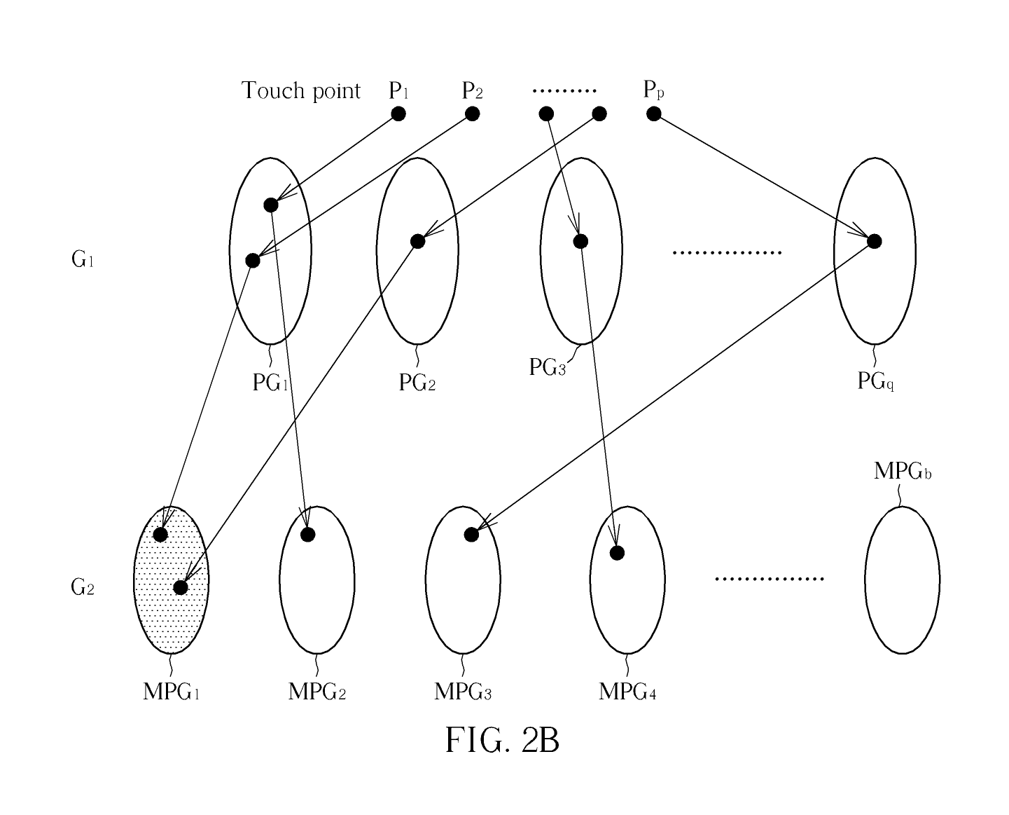

Please refer to FIG. 2A, which is a functional block diagram of a computer system 20 according to an embodiment. As shown in FIG. 2A, the computer system 20 is mainly composed of a touch sensing device 200, a touch control chip 202 and a host 204, wherein the touch sensing device 200 and touch control chip 202 form a touch control system.

The touch sensing device 200 is capable of sensing an object to be detected (e.g. a finger, a pen, etc) and generating one or more detecting signals indicating a position of the object to be detected on a detecting panel (not shown). Furthermore, the touch control chip 202 includes a detection unit 206, a determining unit 208 and a decision unit 210.

The detection unit 206 is utilized for comparing one or more signal values of the one or more detecting signals with one or more threshold values, to determine P touch points P₁-Pₚ and moving patterns MP₁-MPₚ thereof, wherein P is an integer. First, the determining unit 208 is utilized to determine, according to initial positions of the P touch points P₁-Pₚ, respective categories under a position group G₁ to which the P touch points P₁-Pₚ belong. In more detail, there is a plurality of categories PG₁-PG_{q} under the position group G₁, wherein q is an integer. The determining unit 208 determines, according to an initial position of a touch point Pₓ, a category in the plurality of categories PG₁-PG_{q} under the position group G₁ to which the touch point Pₓ belongs, wherein 1≦x≦p. Next, the determining unit 208 further determines, according to moving patterns MP₁-MPₚ defined for each of the respective categories under the position group G₁ to which the P touch points P₁-Pₚ belong, respective categories under a moving pattern group G₂ to which the P touch points P₁-P_{b} belong. In more detail, there is a plurality of categories MPG₁-MPG_{b} under the moving pattern group G₂, wherein b is an integer. The determining unit 208 then determines, according to a moving pattern MPₓ of a touch point Pₓ, a category in the plurality of categories MPG₁-MPG_{b} under the moving pattern group G₂ to which the touch point Pₓ belongs. Note that, each of the categories PG₁-PG_{q} under the position group G₁ may have a different definition for the moving pattern.

The decision unit 210 may in turn decide, according to the determined categories under the moving pattern group G₂ to which each of the P touch points P₁-Pₚ belongs, a gesture GES represented by the P touch points P₁-Pₚ. In more detail, the categories MPG₁-MPG_{b} under the moving pattern group G₂ may correspond to the plurality of gestures GES₁-GES_{b}, respectively. Preferably, the decision unit 210 decide the gesture GES to be a gesture corresponding to a category under the moving pattern group G₂ to which most of the touch points P₁-Pₚ belong. Finally, the decision unit 210 may transmit a packet Pac representing the gesture GES to the host 204.

As a result, the touch control chip 202 does not need to perform complex cross-calculations on various moving pattern parameters of one or more touch points, e.g. relative positions, and is capable of simply deciding the gesture GES to be a gesture corresponding to the most touch points of the P touch points, via categorizing.

For example, please refer to FIG. 2B, which is a schematic diagram of the touch control chip 202 shown in FIG. 2A determining the gesture GES according to an embodiment. The touch control chip 202 first determines, according to the initial positions of the P touch points P₁-Pₚ, respective categories under a position group G₁ to which the P touch points P₁-Pₚ belong. Subsequently, the touch control chip 202 further determines, according to moving patterns MP₁-MPₚ respectively defined for the categories under the position group G₁ respectively to which the P touch points P₁-Pₚ belong, respective categories under a moving pattern group G₂ to which the P touch points P₁-Pₚ belong. Lastly, the gesture GES is decided to be a gesture GES₁ corresponding to a category under the moving pattern group G₂ with the most touch points (e.g. MPG₁).

The following descriptions take a capacitive touch control system as an example to illustrate detailed operations of the detection unit 206, determining unit 208 and decision unit 210 of the touch control chip shown in FIG. 2A. However, the descriptions can be generalized to other types of touch control systems e.g. a resistive touch control system, and the disclosure is not limited to the above given example. The capacitive touch sensing device 200 shown in FIG. 2A generates capacitance signals CX₁-CXₘ, CY₁-CYₙ corresponding to sensing capacitor strings X₁-Xₘ, Y₁-Yₙ as detecting signals, and the detection unit 206 compares the capacitance signals CX₁-CXₘ and CY₁-CYₙ with a vertical threshold value Cvt and a horizontal threshold value Cht, respectively, to determine the P touch points P₁-Pₚ.

More specifically, the detection unit 206 can determine the initial positions of the P touch points P₁-Pₚ if one or more capacitance values of the capacitance signals CX₁-CXₘ are greater than the vertical threshold value Cvt, and one or more capacitance values of the capacitance signals CY₁-CYₙ are greater than the horizontal threshold value Cht. Moreover, the detection unit 206 continues comparing the capacitance signals CX₁-CXₘ, CY₁-CYₙ with the vertical threshold value Cvt and the horizontal threshold value Cht, respectively, to further determine the corresponding P moving patterns MP₁-MPₚ. Note that, the vertical threshold value Cvt and the horizontal threshold value Cht may or may not be the same, depending on practical requirements. Operations of the above-mentioned touch point determination are similar to that of the projected capacitive touch sensing device 10, and thus not described here in further detail.

On the other hand, the determining unit 208 determines, according to relative distances between the initial positions of the P touch points P₁-Pₚ and Q reference positions, respective categories under the position group G₁ to which the P touch points P₁-Pₚ belong, wherein Q is an integer. For example, the Q reference positions may be four corners C₁-C₄ of the touch sensing device 200, a center of the four corners C₁-C₄, a gravity center of the P touch points P₁-Pₚ, or any other positions capable of categorizing the P touch points P₁-Pₚ according to their positions such that there are relative relationships between the positions of the P touch points P₁-Pₚ.

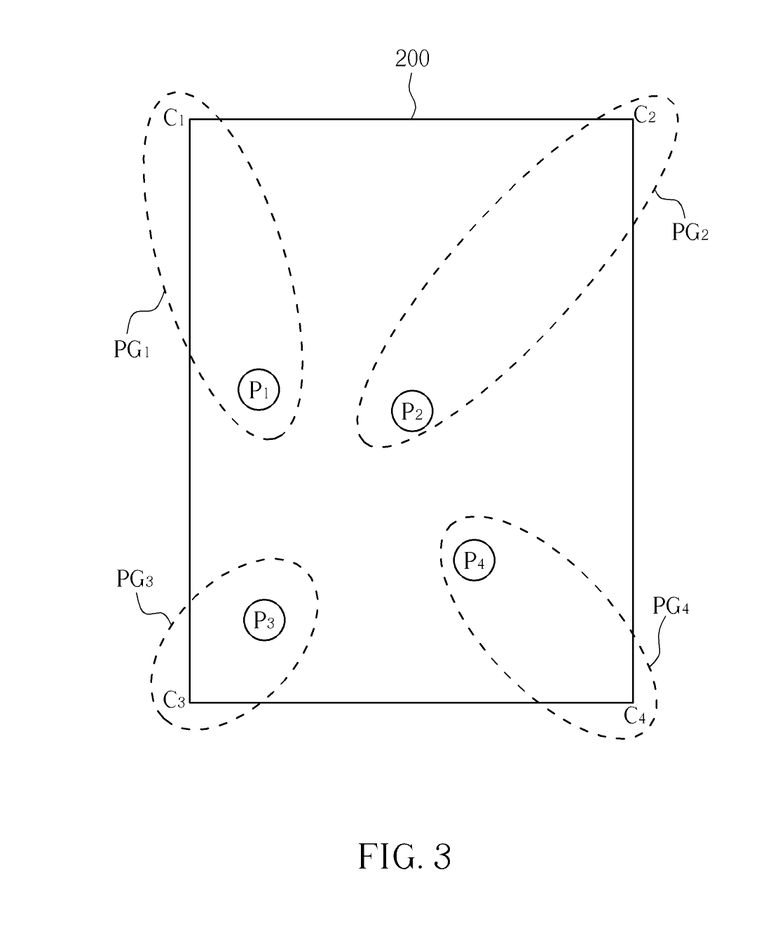

For example, please refer to FIG. 3, which is a schematic diagram illustrating how the determining unit 208 in FIG. 2A categorizes touch points into categories under the position group G₁ according to the initial positions, according to an embodiment. In this embodiment, there are a total of 4 touch points as an example (i.e. P=4); however, this can be generalized to cases with any quantity of total touch points. The Q reference positions are taken to be the four corners C₁-C₄ of the touch sensing device 200. As shown in FIG. 3, when touch points P₁-P₄ occurs during a touch operation, the touch control chip 202 determines, according to distances between the four corners C₁-C₄ and the 4 touch points P₁-P₄, a respective category in the categories PG₁-PG_{q} under the position group G₁ to which each of the touch points P₁-P₄ belongs.

In a preferred embodiment, q=4, i.e. there are four categories PG₁-PG₄ under the position group G₁, corresponding to the four corners C₁-C₄, respectively. When the touch control chip 202 determines that a corner C_{y} is closest to a touch point Pₓ in distance, it may be determined that the touch point Pₓ belongs to the category PGy under the position group G₁ (wherein 1≦x≦p, 1≦y≦4); all other cases may be similarly inferred by analogy.

Note that, when a quantity of the touch points P₁-Pₚ exceed a quantity of the categories PG₁-PG_{q} (e.g. a quantity of touch points exceed four in FIG. 3), the touch control chip 202 may further equally distribute the touch points P₁-Pₚ into the categories PG₁-PG_{q} under the position group G₁. For example, when q=4, it is possible to set an upper limit for touch points in each of the categories PG₁-PG_{q} to be one-fourth of the quantity of the touch points P₁-Pₚ (rounded up unconditionally), and a lower limit as one-fourth of the quantity of the touch points P₁-Pₚ (rounded down unconditionally). Simply put, a first touch point is distributed to each of the categories PG₁-PG_{q}, respectively according to the distances between the four corners C₁-C₄ and the 4 touch points P₁-P₄. After each of the categories PG₁-PG_{q} has been assigned a first corresponding touch point, if there are any remaining touch points not assigned to any category, each of the categories PG₁-PG_{q} can be further assigned a second touch point, and so on.

Next, the following describes how the determining unit 208 in FIG. 2A categorizes the touch points into different categories under the moving pattern group G₂, according to the moving patterns. In a preferred embodiment, for each of the categories under the position group G₁, each of the moving patterns MP₁-MPₚ of the touch points P₁-Pₚ, respectively, can be defined by one or more moving pattern parameters. The one or more moving pattern parameters may, for an example, include at least one of a direction parameter, a distance parameter, and a time parameter. In other words, the determining unit 208 determines, according to the at least one of the direction parameter, distance parameter and time parameter that defines each of the moving pattern MP₁-MPₚ for each of the categories under the position group G₁ to which the P touch points P₁-Pₚ belong, a respective category under the moving pattern group G₂ to which the P touch points P₁-Pₚ belong.

In a specific embodiment, in each of the categories under the position group G₁, each respective moving pattern MP₁-MPₚ of the touch points P₁-Pₚ may be defined by a direction parameter indicating one of a plurality of moving directions. The plurality of moving directions corresponds to the plurality of categories under the moving pattern group G₂, respectively. Therefore, the determining unit 208 may determine, according to the direction parameters of the P touch points P₁-Pₚ, a respective category corresponding to the moving direction represented by each of the direction parameters to which each of the P touch points P₁-Pₚ belongs.

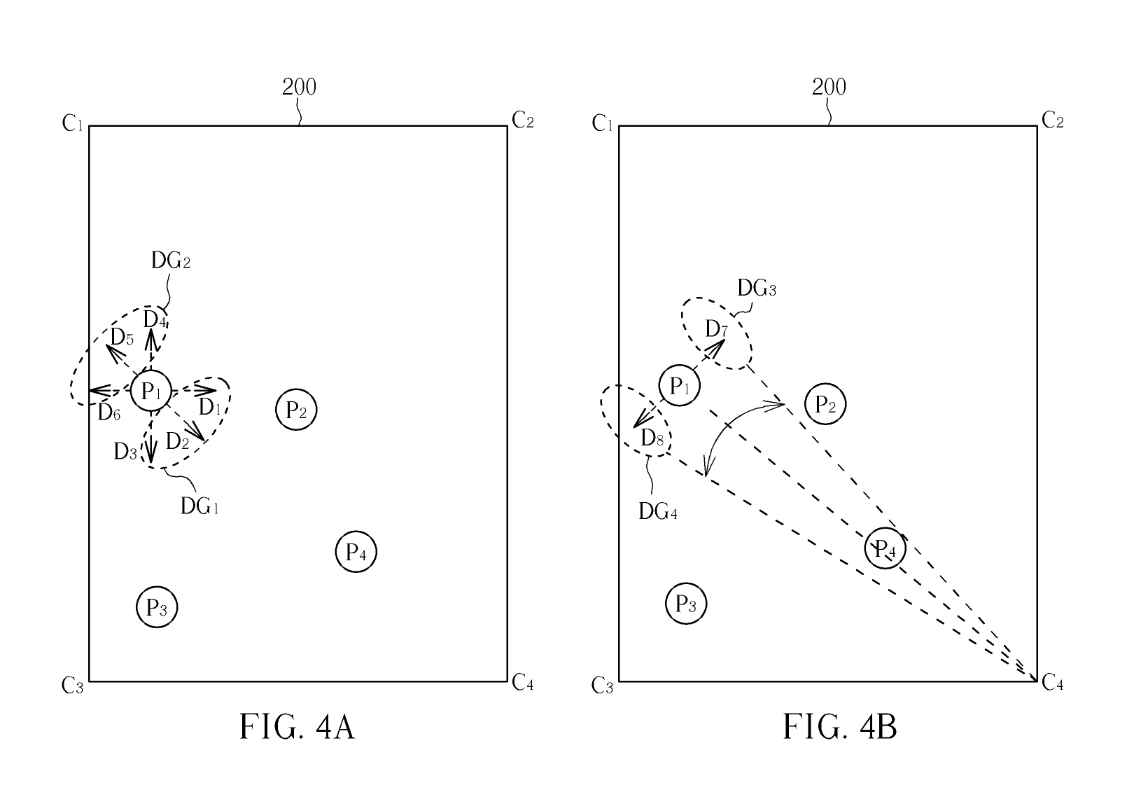

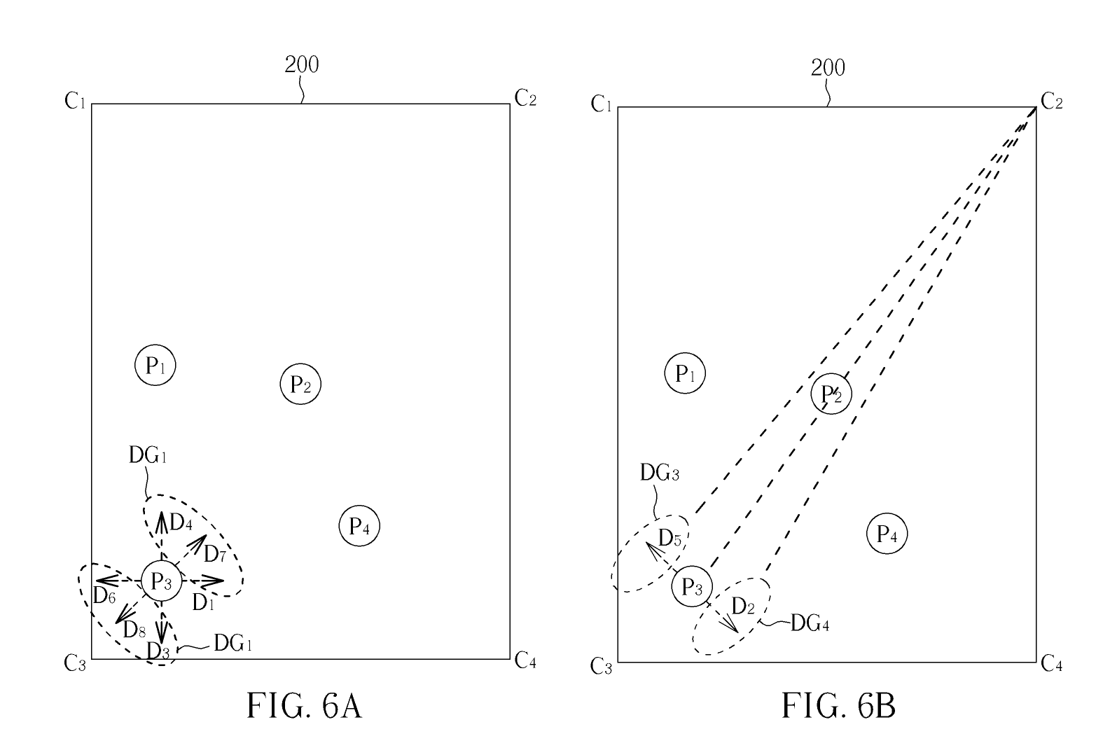

FIGS. 4A-4B to FIGS. 7A-7B are respective schematic diagrams showing how the determining unit 208 in FIG. 2A perform categorizing operations according to the moving patterns defined for each of the different categories, for each of the different categories under the moving pattern group G₂, according to an embodiment. This embodiment is implemented according to the categorizing operations of the position group G₁ shown in FIG. 3. The moving patterns MP₁-MPₚ of the categories PG₁-PG₄ under the position group G₁ are defined by the direction parameter, respectively. In this embodiment, there are a total of 4 touch points as an example (i.e. P=4); however, this can be easily generalized for any quantity of total touch points.

Firstly, please refer to FIGS. 4A and 4B, which are schematic diagrams showing how the determining unit 208 shown in FIG. 2A perform categorizing operations according to the moving patterns for the category MPG₁ under the moving pattern group G₂, according to the embodiment. After the determining unit 208 determines that the touch point Pₓ (wherein 1≦x≦p) belongs to the category PG₁ (corresponding to the corner C₁) under the position group G₁ according to the above-mentioned methods, it may further determine, according to the moving pattern MP₁ defined by the direction parameter in category PG₁, a category under the moving pattern group G₂ to which the touch point Pₓ belongs. In this example, the touch point P₁ is categorized into the category PG₁ under the position group G₁; thus, the touch point P₁(x=1) is taken as an example to illustrate the following.

As shown in FIGS. 4A and 4B, when the direction parameter indicates that the touch point P₁ is moving along directions D1, D₂, D₃ (i.e. moving towards a direction of an opposite corner C4 corresponding to the corner C₁), the determining unit 208 determines that the touch point P₁ belongs to a category DG₁ under the moving pattern group G₂. When the direction parameter indicates that the touch point P₁ is moving along directions D₄, D₅, D₆ (i.e. moving towards a direction corresponding to the corner C₁), the determining unit 208 determines that the touch point P₁ belongs to a category DG₂ under the moving pattern group G₂. When the direction parameter indicates that the touch point P₁ is moving along a direction D₇ (i.e. moving towards a direction of an adjacent corner C2 corresponding the corner C₁), the determining unit 208 determines that the touch point P₁ belongs to a category DG₃ under the moving pattern group G₂. When the direction parameter indicates that the touch point P₁ is moving along a direction D₈ (i.e. moving towards a direction of another adjacent corner C₃ corresponding to the corner C₁), the determining unit 208 determines that the touch point P₁ belongs to a category DG₄ under the moving pattern group G₂.

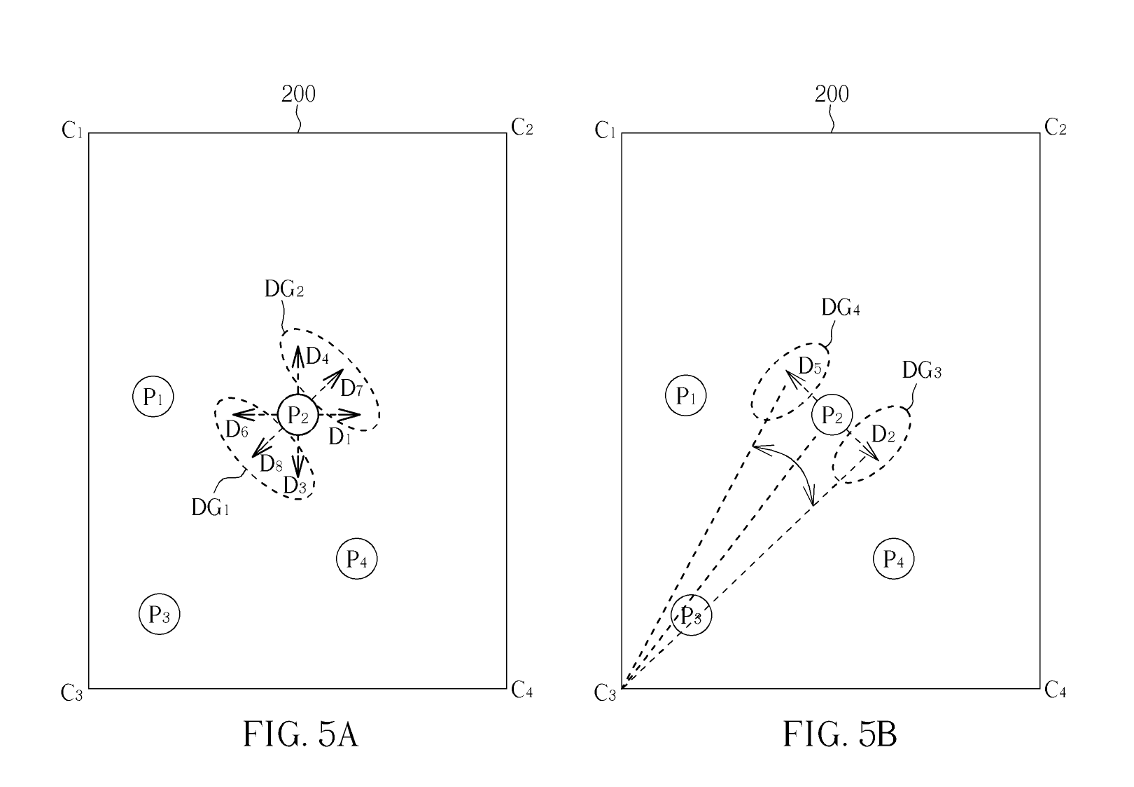

Similarly, according to the above-mentioned descriptions for first category PG₁ in FIGS. 4A and 4B, it is possible to determine, for a touch point in the other categories PG₂-PG₄ under the position group G₁, which of the four categories DG₁-DG₄ under the moving pattern group G₂ the touch point belongs to, respectively, according to the moving patterns defined by the direction parameter. Please refer to FIGS. 5A and 5B, FIGS. 6A and 6B, and FIGS. 7A and 7B, respectively, for detailed descriptions of categorizing touch points into the other categories PG₂-PG₄ under the position group G₂, which are not iterated here in further detail.

In summary of the above-mentioned embodiment, as shown in FIGS. 4A-4B to FIGS. 7A-7B, for each of the categories PG₁-PG_{q} under the position group G₁, the plurality of directions indicated by the direction parameter includes: moving towards a direction of an opposite corner of one of the four corners, moving towards a direction corresponding to one of the four corners, moving towards a direction of an adjacent corner of one of the four corners, and moving towards a direction of another adjacent corner of one of the four corners. Simply put, each of the different categories PG₁-PG_{q} under the position group G₁ corresponds to a different corner; thus, the absolute directions of the plurality of directions indicated by the direction parameter are also different. As such, for each of the P touch points P₁-Pₚ, the determining unit 208 needs to first categorize the touch points under the position group G₁ to determine a moving direction in the group to which each touch point belongs, in order to further categorize the touch points under the moving pattern group G₂.

In further detail, please compare FIGS. 4A and 4B to FIGS. 7A and 7B. It is clear that the directions for determining the touch points P₁, P₂ to be in the categories DG₁-DG₄ are different for the categories PG₁ and PG₂, i.e. the absolute directional conditions for determining touch points to be in the categories DG₁-DG₄ are not the same for different categories under the position group G₁; instead, the absolute directional conditions defined for each of the above-mentioned four directions are used to determine the categories DG₁-DG₄ to which the touch points belong.

The following are detailed descriptions of operations of the decision unit 210 in FIG. 2A. In a preferred embodiment employing the categorizing criteria of FIG. 3 and FIGS. 4A-4B to FIGS. 7A-7B, it is possible to arrange the categories DG₁-DG₄ under the moving pattern group G₂ to correspond to a zoom-out gesture, zoom-in gesture, a clock-wise and counterclockwise rotation gesture, respectively. However, possible arrangements are not limited to the above-mentioned description. In another embodiment, how the direction parameters correspond to the categories and the gestures is not limited to having four directions correspond to the four categories DG₁-DG₄ and the four gestures, as in the above-mentioned embodiment. Instead, it is possible to have directions D1-D₈ respectively correspond to eight categories and eight gestures (i.e. a total of eight corresponding gestures), or any other variation.

In summary of the above, the touch control chip 202 does not need to continuously perform concurrent and complex cross-calculations between the touch points P₁-P₄ to obtain the absolute relative relationship. Instead, as shown in FIG. 3, it is a simpler alternative to first categorize the touch points into categories under the position group G₁ according to the initial position of each of the touch points, then, as shown in FIGS. 4A-4B to FIGS. 7A-7B, categorize the touch points into categories under the moving pattern group G₂ according to the moving pattern of each of the touch points. Finally, the gesture GES to which all of the touch points correspond is determined to be a gesture corresponding to the category with the absolute majority of the touch points.

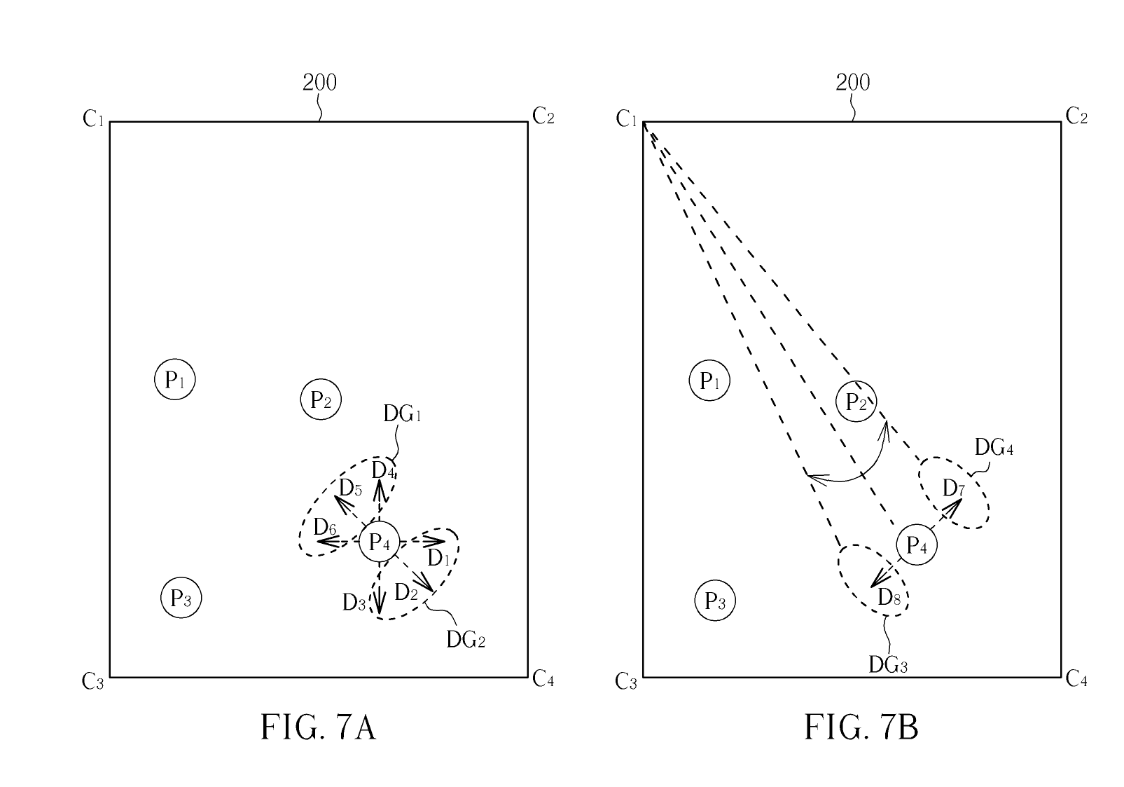

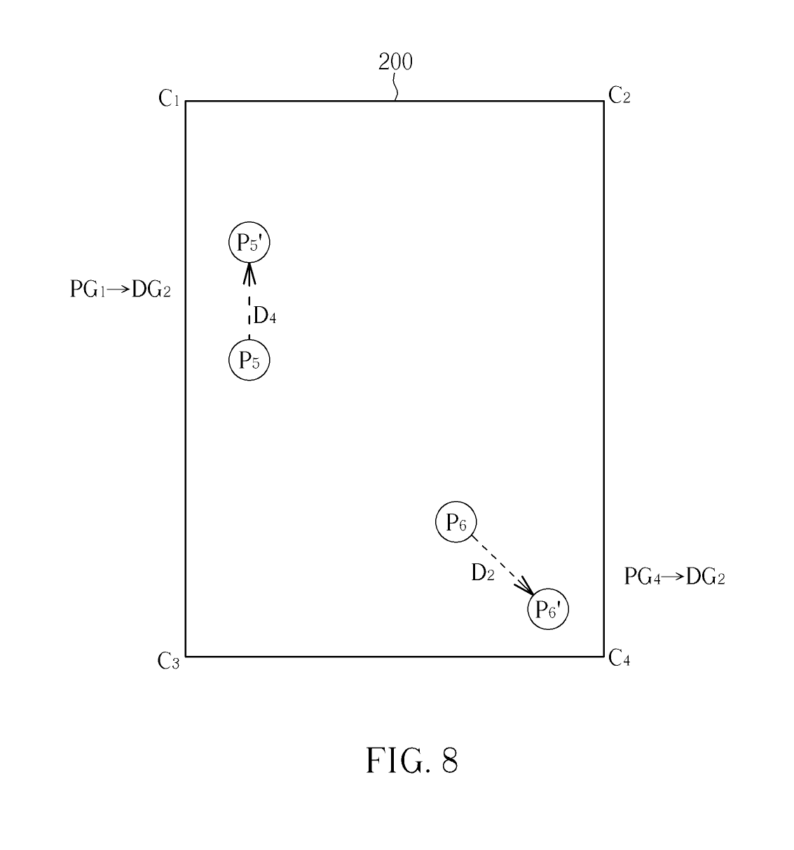

The following are further examples illustrating different applications of applying the embodiment of FIG. 3 to FIGS. 4A-4B and FIGS. 7A-7B. Firstly, please refer to FIG. 8, which is a schematic diagram of the touch control chip 202 deciding the gesture GES to which 2 touch points P₅ and P₆ correspond, according to an example. As shown in FIG. 8, when the touch control chip 202 is detecting the touch points P₅ and P₆, it can be determined that the touch points P₅, P₆ belong to the categories PG₁, PG₄ under the position group G₁, respectively, according to the categorizing criteria shown in FIG. 3. As shown in FIG. 8, the touch point P₅, P₆ move along the directions D₄, D₂, respectively, to touch points P₅′, P₆′. As a result, in accordance with the categorizing criteria for the category PG₁ shown in FIG. 4A-4B, the touch control chip 202 can determine that the touch point P₅ belongs to the category DG₂ under the moving pattern group G₂, according to the moving direction D₄ indicated by the direction parameter under the category PG₁. Similarly, in accordance with the categorizing criteria for the category PG₄ shown in FIGS. 7A-7B, the touch control chip 202 can determine that the touch point P₆ belongs to the category DG₂ under the moving pattern group G₂, according to the moving direction D₂ indicated by the direction parameter under the category PG₄. Finally, since the category DG₂ is the category having the absolute majority of touch points in the touch points P₅ and P₆, the touch control chip 202 may decide that the gesture GES represented by all of the touch points P₅, P₆ is the gesture corresponding to the category DG₂, e.g. in this case, a zoom-in gesture.

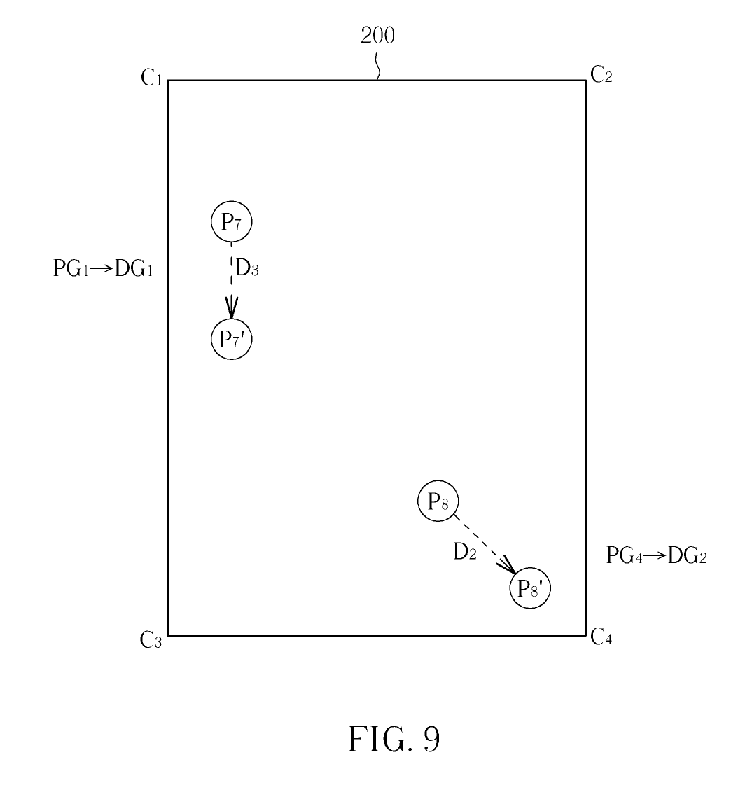

Next, please refer to FIG. 9, which is a schematic diagram of the touch control chip 202 deciding the gesture GES to which two touch points P₇, P₈ correspond, according to another example. As shown in FIG. 9, when the touch control chip 202 is detecting the touch points P₇ and P₈, it can be first determined that the touch points P₇, P₈ belong to the categories PG₁, PG₄ under the position group G₁, respectively. Next, as shown in FIG. 9, the touch point P₇, P₈ move along the directions D₃, D₂ to touch points P₇′, P₈′, respectively. As a result, the touch control chip 202 can determine that the touch point P₇ belongs to the category DG₁ under the moving pattern group G₂, according to the moving direction D₃ indicated by the direction parameter under the category PG₁. Similarly, the touch control chip 202 can determine that the touch point P₈ belongs to the category DG₂ under the moving pattern group G₂, according to the moving direction D₂ indicated by the direction parameter under the category PG₄. Finally, since there is no category having an absolute majority of touch points in the touch points P₇ and P₈, the touch control chip 202 decides that the gesture GES represented by all of the touch points P₅, P₆ is a null gesture, to prevent a faulty determination.

Note that, the essence of the above-mentioned embodiments is to first determine a category under a first group to which touch points belong, according to initial positions of the touch points, and then determine a category under a second group to which the touch points belong, according to a moving pattern defined for each of the categories under the first group to which each of the touch points belong, respectively. In turn, it may be decided that a gesture corresponding to a category under the second group to which a majority of the touch points belong, is the gesture represented by the touch points. Therefore, the embodiments are capable of determining a gesture represented by the touch points, without having to continuously perform concurrent and complex cross-calculations between the touch points. When there is not a gesture with the most touch points, the gesture represented by all of the touch points is decided to correspond to a non-gesture, to prevent faulty determination. Suitable modifications and alterations may be made accordingly by those skilled in the art, and are not limited thereto.

Specifically, in the above-mentioned embodiment, the moving patterns are all defined by a single moving pattern parameter (e.g. the direction parameter), such that the determining unit 208 may simply determine the category under the moving pattern group G₂ to which the touch points belong and the corresponding gesture, solely according to the direction parameter. However, in other embodiments, the moving patterns may be defined by multiple moving pattern parameters having different priority orders.

For example, in certain embodiments, the determining unit 208 may determine a category of multiple categories under the moving pattern group G₂ to which the each of the P touch points P₁-Pₚ belongs, respectively, according to multiple moving pattern parameters. Next, for each touch point, the determining unit 208 may select a category corresponding to a higher priority parameter as the category to which the touch point belongs, according to the priority orders of these moving pattern parameters. Finally, the decision unit 201 can determine the gesture represented by the touch points to be a gesture corresponding to a category with most of the touch points.

Furthermore, in other embodiments, the determining unit 208 can further determine whether each touch point represents a gesture or non-gesture, respectively, according to at least one of these moving pattern parameters. Next, the determining unit 208 further determines whether the gesture selected by the decision unit 201 corresponding to the category under the second group is substantiated, according to the priority orders of these moving pattern parameters. Lastly, the decision unit 201 decides a gesture corresponding to the category with the most touch points as the gesture represented by the touch points.

For example, refer back to FIG. 8. It is possible to configure the moving pattern MP₅ to be further defined by an additional distance parameter, in addition to the original direction parameter, and that the distance parameter can have a higher priority order over that of the direction parameter. In such a case, it is required that the touch control chip 202 determines a gesture only when the touch point P₅ moves to the touch point P₅′ for a distance greater than a specific distance; conversely, it determines the touch points represent a non-gesture. In other words, even after the touch point P₅ is determined to belong to the category DG₂ according to direction D₄ of the direction parameter, the gesture represented by the touch point P₅ may be determined to be a non-gesture if the touch point P₅ moves to the touch point P₅′ for a distance shorter than the specific distance. As such, the touch control chip 202 may determine the gesture represented by each of the touch points, according to a combination of the different moving pattern parameters of the moving pattern, thereby preventing a faulty determination.

Note that, the above-mentioned embodiment only serves to illustrate a way of utilizing the priority order of each of the parameters in a moving pattern, and the distance parameter is utilized for determining whether gestures determined by other parameters are substantiated or not. The following further illustrate various cases with different embodiments.

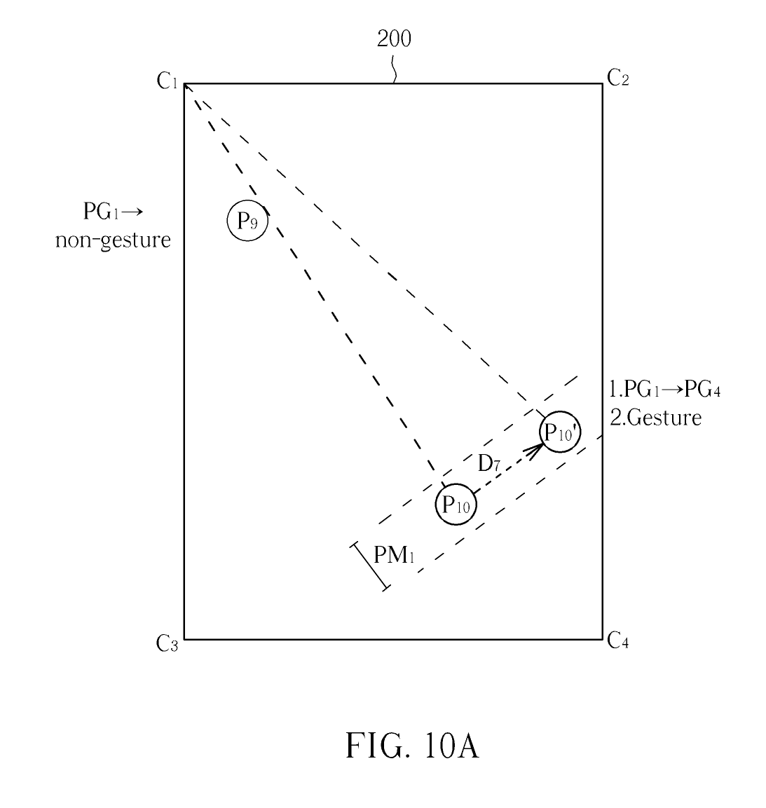

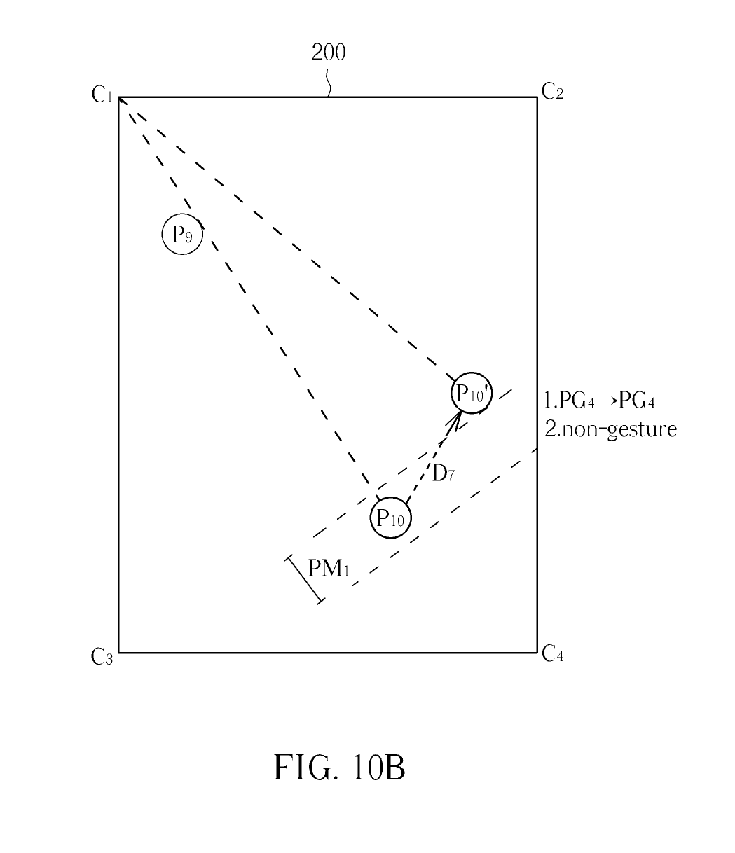

Please refer to FIGS. 10A and 10B, which are schematic diagrams two further examples of the touch control chip 202 in FIG. 2A deciding a gesture, according to another embodiment utilizing order priority parameters. In this embodiment, the touch control chip 202 decides the gesture GES corresponding to the two touch points P₉, P₁₀. As shown in FIG. 10A, when the touch control chip 202 is detecting the touch points P₉, P₁₀, it can be determined that the touch points P₉, P₁₀ belong to the categories PG₁, PG₄ under the position group G₁, respectively. Next, categorizing operation under the moving pattern group G₂ is performed. In accordance to categorizing the touch point P₉ according to the distance parameter, since the touch point P₉ does not move, the touch control chip 202 determines that the touch point P₉ represents a non-gesture. Combining the determination according to the two moving pattern parameters, since the distance parameter has a higher priority order than that of the direction parameter, it can be determined that the touch point P₉ represents a non-gesture. Similarly, as for categorizing the touch point P₁₀ according to the direction parameter, since the touch point P₁₀ moves along the direction D₇ to a touch point P₁₀′, the touch control chip 202 can determine that the touch point P₁₀ belongs to the category DG₄ under the moving pattern group G₂, according to the direction D₇ indicated by the direction parameter. Moreover, concerning the categorizing of the touch point P₁₀ according to the distance parameter, since the distance parameter indicates that a moving trail from the touch point P₁₀ to the touch point P₁₀′ is within a predefined error margin PM₁ (e.g. a distance between the touch points P₁₀, P₁₀′ and the corner C₁ is a fixed within a specific distance), the determining unit 208 may determine that the touch point P₁₀ represents a gesture. Combining the determinations according to two moving pattern parameters, since the distance parameter has a higher priority order than that of the direction parameter, it can be determined that the touch point P₁₀ belongs to the category DG₄. Finally, combining the above-mentioned determinations, since category DG₄ is the category accounting for an absolute majority of the touch points, the touch control chip 202 decides that the gesture GES represented by all of the touch points P₉, P₁₀ is a gesture corresponding to the category DG₄ (e.g. a counter-clockwise rotation gesture).

Conversely, as shown in FIG. 10B, the difference between FIGS. 10B FIG. 10A is that the distance parameter of the touch point P₁₀ indicates a moving trail from the touch point P₁₀ to the touch point P₁₀′ is outside a predefined error margin PM₁, therefore it is determined that the touch point P₁₀ represents a non-gesture. Since the touch points P₉ and P₁₀ both represent non-gestures, the second group G₂ does not have a category with absolute majority of touch points. As a result, the touch control chip 202 decides that the gesture GES represented by all of the touch points P₉, P₁₀ is a non-gesture, so as to prevent a faulty determination. Note that, in the above-mentioned case of FIGS. 10A and 10B, since the touch control chip 202 may as shown in FIG. 9 further determine a corresponding gesture GES different from specific gestures to be a non-gesture, according to the direction parameters of the touch points P₉, P₁₀. Therefore, this yields a smaller predefined error margin PM₁ for preventing faulty determinations than the prior art.

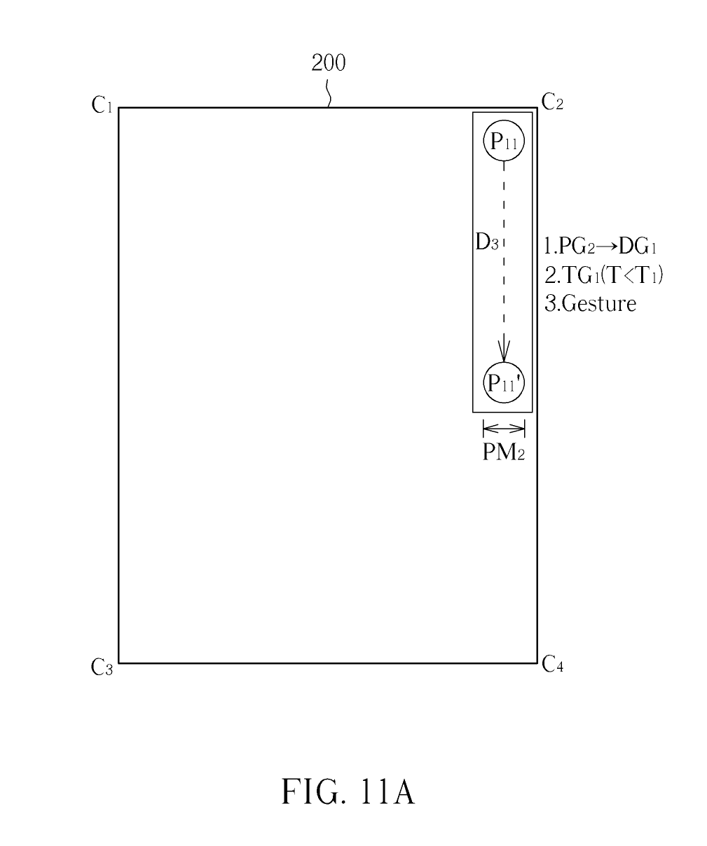

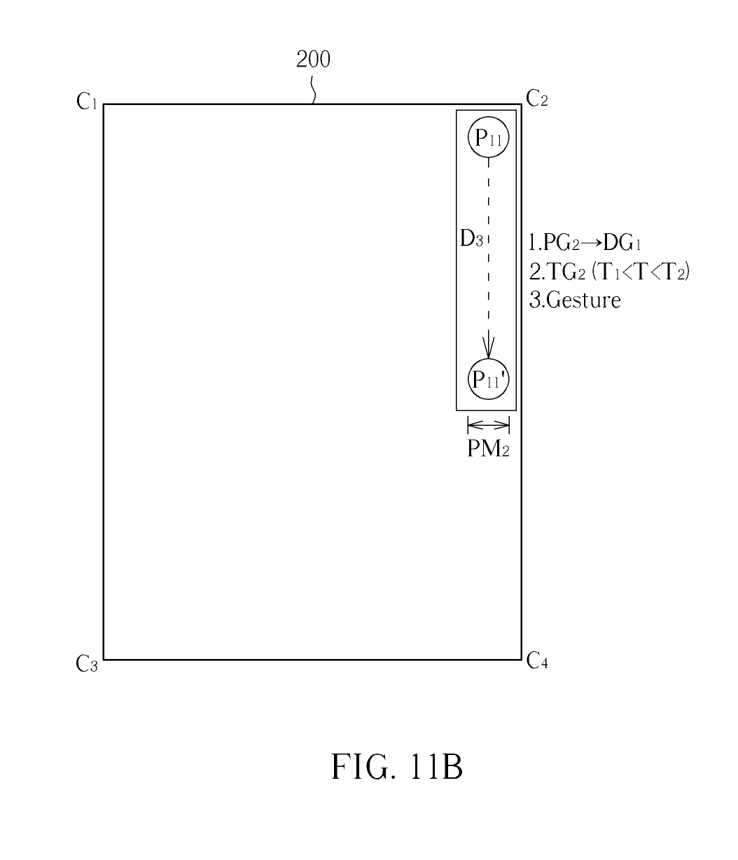

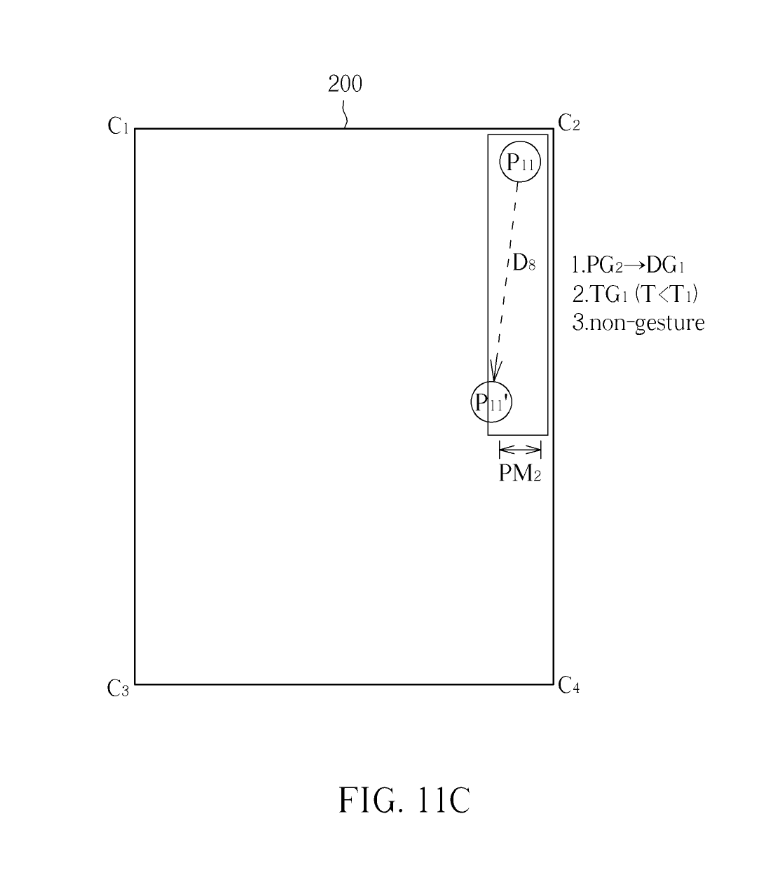

Furthermore, the present invention is not limited to multi-touch gesture determination applications, and can also be applied in single-finger gesture determination. For example, please refer to FIGS. 11A and FIG. 11C, which are schematic diagrams illustrating how the touch control chip 202 in FIG. 2A decides the gesture GES represented by a touch point P₁₁, according to an embodiment. In this embodiment, the moving pattern is defined by three moving pattern parameters: a direction parameter, distance parameter, and time parameter, wherein the distance parameter has a higher priority order over that of the time parameters, and the time parameter has a higher priority order over that of the direction parameter.

As shown in FIG. 11A, when the touch control chip 202 is detecting the touch point P₁₁, it can be first determined that the touch point P₁₁ belongs to the category PG₂ under the position group G₁. Next, concerning the categorizing according to the direction parameter, since the touch point P₁₁ moves along the direction D₃ to the touch point P₁₁′, the touch control chip 202 may determine that the touch point P₁₁ belongs to the category DG₁ under the moving pattern group G₂ according to the direction D₃ indicated by the direction parameter, in accordance with the categorizing criteria under the category PG₂ in FIGS. 5A-5B. On the other hand, concerning the categorizing according to the time parameters, since the time parameters indicates that the time T in which the touch point P₁₁ moves to the touch point P₁₁′ is within a predefined time T₁, the touch control chip 202 may determine that the touch point P₁₁ belongs to a category TG₁. On the other hand, as for the categorizing according to the distance parameter, since the distance parameter indicates that a moving trail along which the touch point P₁₁ moves to the touch point P₁₁′ is within a predefined error margin PM₂ and greater than a specific distance, the touch control chip 202 may determine that the touch point P₁₁ represents a gesture. Lastly, combining the above-mentioned determinations according to the three moving pattern parameters according to their priority orders, the touch control chip 202 ultimately determines that the touch point P₁₁ belongs to the category TG₁. In addition, the category TG₁ has an absolute majority of the touch points; therefore, the touch control chip 202 decides that the gesture GES is a gesture corresponding to the category TG₁ (e.g. a flip gesture).

In another example, as shown in FIG. 11B, the difference between FIGS. 11B and 11A is that the time parameters determines that a time T in which the touch point P₁₁ moves to the touch point P₁₁′ is longer than a predefined time T₁ and shorter than a predefined time T₂; therefore, the touch control chip 202 determines that the touch point P₁₁ belongs to another category TG₂. Similar to the above-mentioned descriptions of FIG. 11A, according to priority orders of the three parameters, the touch control chip 202 ultimately determines that the touch point P₁₁ belongs to the category TG₂. Also, the category TG₂ has the absolute majority of the touch points; therefore, the touch control chip 202 decides that the gesture GES is gesture corresponding to the category TG₂ (e.g. a slide gesture).

Furthermore, in yet another example, as shown in FIG. 11C, the difference between FIGS. 11C and 11A is that the distance parameter indicates that the moving trail along which the touch point P₁₁ moves to the touch point P₁₁′ is outside the predefined error margin PM₂; therefore, it can be determined that the touch point P₁₁ represents a non-gesture. According to priority orders of the three parameters, plus the non-gesture is determined to be the absolute majority, the touch control chip 202 ultimately decides that the gesture GES is a non-gesture, to prevent a faulty determination.

The various above-mentioned embodiments for deciding corresponding gestures of the touch points according to different parameters of the moving pattern may be subject to modifications and alterations by those skilled in the art, and are not limited thereto. For example, the parameters of the moving pattern are not limited to direction, distance and time parameters. The quantity and conditions for deciding gestures are not limited to the above-mentioned embodiments, i.e. eight direction conditions corresponding to four categories and their corresponding gestures; one time condition corresponding to gestures or non-gestures; and two time conditions corresponding to two categories and their corresponding gestures. Instead, it is possible to use different combinations of priority orders, so long as actual requirements are met. Moreover, in the above-mentioned embodiment, the distance parameter is only used for distinguishing between a gesture or a non-gesture, whereas in fact, it may be used for determining a specific gesture just as the other moving pattern parameters, e.g. small range movements and large range movements may be determined as different gestures.

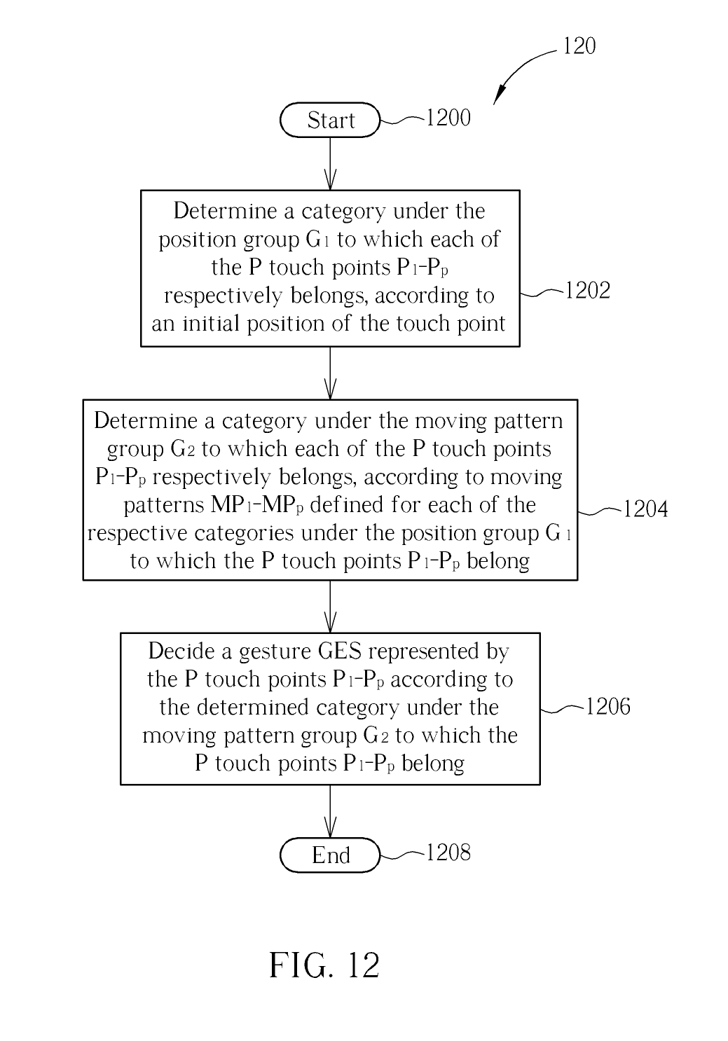

The single-finger gesture determination method in the above-mentioned embodiments may be summarized into a single-finger and multi-touch gesture determination process 120, as shown in FIG. 12, including the following steps:

Step 1200: An initialization step, representing a start of the process.

Step 1202: A position group categorizing step, including determining the category under the position group G₁ to which each of the P touch points P₁-Pₚ respectively belongs, according to an initial position of the touch point.

Step 1204: A moving group categorizing step, including determining the category under the moving pattern group G₂ to which each of the P touch points P₁-Pₚ respectively belongs, according to moving patterns MP₁-MPₚ defined for each of the respective categories under the position group G₁ to which the P touch points P₁-Pₚ belong.

Step 1206: A gesture deciding step, including deciding a gesture GES represented by the P touch points P₁-Pₚ according to the determined categories under the moving pattern group G₂ respectively to which the P touch points P₁-Pₚ belong.

Step 1208: A termination step, representing an end of the process.

wherein details for each step may be inferred by analogy from operations of corresponding components of the touch control chip 202, and are not further reiterated here.

In summary of the above-mentioned, when determining a multi-touch gesture in the prior art, it is necessary to continuously perform concurrent and complex cross-calculations between multiple touch points, to decide a corresponding multi-touch gesture. Therefore, this constant calculation of relative variations renders the determination process over-complicated. Also, it is necessary to set larger error margins to prevent a faulty determination. Comparatively, the above-mentioned embodiments are capable of determining a category under a first group to which the touch point belongs according to the initial position of each touch point, then determining a category under a second group to which the touch points belong, according to a moving pattern defined for each of the categories under the first group. In turn, the gesture represented by the touch points can be determined to be a gesture corresponding to a category under the second group to which a majority of the touch points belong. Therefore, the embodiments are capable of determining a gesture represented by the touch points, without having to continuously perform concurrent and complex cross-calculations between the touch points. It is also possible to apply the embodiments to single-finger gesture determination. Moreover, apart from deciding corresponding gestures of the touch points according to the moving pattern defined by moving pattern parameters such as direction, distance and time, respectively, the above-mentioned embodiments are capable of further employing priority orders of the parameters to prevent faulty determinations. Moreover, the above-mentioned embodiments can further decide that the gesture to which all of the touch points correspond is a non-gesture, when there is not a gesture with an absolute majority of touch points, and therefore can reduce the error margin for preventing a faulty gesture determination.

As a result, the above-mentioned embodiments do not need to constantly continuously perform concurrent and complex cross-calculations between the relative positions and other moving pattern parameters of the one or more touch points. Instead, the above-mentioned embodiments can simply decide a gesture, while reducing the required error margin for preventing faulty gesture determination.

Those skilled in the art will readily observe that numerous modifications and alterations of the device and method may be made while retaining the teachings of the invention.

What is claimed is:

1. A single-finger and multi-touch gesture determination method, comprising:
for each of one or more touch points, judging a respective category under a first group to which the touch point belongs, according to an initial position of the touch point;
for each of the one or more touch points, judging a respective category under a second group to which the touch point belongs, according to a moving pattern of the touch point, wherein the moving pattern is respectively defined in the judged category under the first group to which the touch point belongs; and
determining a gesture represented by the one or more touch points according to the judged categories under the second group respectively to which the one or more touch points belong.

2. The single-finger and multi-touch gesture determination method of claim 1, wherein a plurality of categories under the second group respectively correspond to a plurality of gestures, and the determined gesture is a gesture corresponding to a category under the second group to which most of the touch points belong.

3. The single-finger and multi-touch gesture determination method of claim 1, wherein the step of determining the respective category under the first group to which each of the one or more touch points belongs comprises a step of:
for each of the one or more touch points, determining the respective category under the first group to which the touch point belongs, according to relative distances between the initial position of the touch point and one or more reference positions.

4. The single-finger and multi-touch gesture determination method of claim 3, wherein the one or more reference positions are four corners of a touch sensing device, a center of the four corners or a gravity center of the one or more touch points.

5. The single-finger and multi-touch gesture determination method of claim 3, wherein the step of determining the respective category under the first group to which the one or more touch points belong further comprises a step of:
equally distributing the one or more touch points to the plurality of categories under the first group.

6. The single-finger and multi-touch gesture determination method of claim 1, wherein the moving pattern of each category under the first group is defined by one or more moving pattern parameters, which comprise at least one of a direction parameter, a distance parameter and a time parameter.

7. The single-finger and multi-touch gesture determination method of claim 6, wherein the direction parameter indicates one of a plurality of moving directions respectively corresponding to a plurality of categories under the second group, and the step of judging the respective categories under the second group to which the one or more touch points belong comprises a step of:
determining that the one or more touch points respectively belong to a category corresponding to the moving direction indicated by the direction parameter.

8. The single-finger and multi-touch gesture determination method of claim 7, wherein first to fourth categories under the first group respectively correspond to first to fourth corners of a touch sensing device, and the plurality of directions under each of the first to fourth categories respectively comprise: a direction towards an opposite corner of one of the four corners, a direction towards a corresponding corner of the first to the fourth corners, a direction towards an adjacent corner of one of the four corners, and a direction towards another adjacent corner of one of the four corners.

9. The single-finger and multi-touch gesture determination method of claim 8, wherein the step of judging the respective category under the second group to which the one or more touch points belong according to a moving pattern comprises steps of:
for each of the one or more touch points, respectively determining one or more probable categories under the second group to which the touch point may belong, according to the one or more moving pattern parameters, respectively; and
for the each touch point, selecting one of the one or more probable categories to which the touch point may belong as the category under the second group to which the touch point belongs according to priority orders of the one or more moving pattern parameters.

10. The single-finger and multi-touch gesture determination method of claim 9, wherein the step of judging the respective category under the second group to which the one or more touch points belong according to the moving pattern further comprises steps of:
determining whether the each touch point respectively represents a gesture or a non-gesture, according to at least one of the one or more moving pattern parameters, respectively; and
further determining whether the gesture corresponding to the selected category under the second group to which the touch point belongs is substantiated or not, according to the priority orders of the one or more moving pattern parameters.

11. A touch control chip, comprising:
a determining unit, for determining a respective category under a first group to which each of a plurality of touch points belongs, according to an initial position of the touch point, and for determining a respective category under a second group to which each of the plurality of the touch points belongs, according to a moving pattern respectively defined in the determined category under the first group to which the touch point belongs; and
a decision unit, for determining a gesture represented by the one or more touch points according to the respective determined categories under the second group to which the one or more touch points belong.

12. The touch control chip of claim 11, wherein a plurality of categories under the second group respectively correspond to a plurality of gestures, and the decision unit determines the gesture is a gesture corresponding to a category under the second group to which most of the touch points belong.

13. The touch control chip of claim 11, wherein the determining unit determines the respective category under the first group to which each of the one or more touch points belongs according to relative distances between the initial position of the touch point and one or more reference positions.

14. The touch control chip of claim 13, wherein the one or more reference positions are four corners of a touch sensing device, a center of the four corners or a gravity center of the one or more touch points.

15. The touch control chip of claim 13, wherein the determining unit equally distributes the one or more touch points to the plurality of categories under the first group.

16. The touch control chip of claim 11, wherein the moving pattern of each category under the first group is defined by one or more moving pattern parameters, and the one or more moving pattern parameters comprising at least one of a direction parameter, a distance parameter and a time parameter.

17. The touch control chip of claim 16, wherein the direction parameter indicates one of a plurality of moving directions, and the plurality of moving directions respectively correspond to a plurality of categories under the second group, and the determining unit determines that the one or more touch points respectively belong to a category corresponding to the moving direction indicated by the direction parameter.

18. The touch control chip of claim 17, wherein a first to a fourth category under the first group respectively correspond to a first to a fourth corner of a touch sensing device, and the plurality of directions under each of the first to the fourth category respectively comprises: a direction towards an opposite corner of one of the four corners, a direction towards a corresponding corner of the first to the fourth corners, a direction towards an adjacent corner of one of the four corners, and a direction towards another adjacent corner of one of the four corners.

19. The touch control chip of claim 18, wherein for each of the one or more touch points, the determining unit respectively determines one or more probable categories under the second group to which the touch point may belong, according to the one or more moving pattern parameters, respectively, and for the each touch point, the determining unit selects one of the one or more probable categories to which the touch point may belong, as the category under the second group to which the touch point belongs, according to priority orders of the one or more moving pattern parameters.

20. The touch control chip of claim 19, the determining unit further determines whether the each touch point respectively represents a gesture or a non-gesture, according to at least one of the one or more moving pattern parameters, respectively, and further determines whether the gesture corresponding to the selected category under the second group to which the touch point belongs is substantiated or not, according to the priority orders of the one or more moving pattern parameters.

21. A touch control system, comprising:
a touch sensing device, for generating one or more signal values of one or more detecting signals; and
the touch control chip of claim 11, for determining one or more touch points and a gesture represented by the one or more touch points, according to the one or more signal values of the one or more detecting signals generated by the touch sensing device.

22. A computer system, comprising:
the touch control system of claim 21, for determining a gesture represented by one or more touch points; and
a host, for receiving a packet of the gesture from the touch control system.
